(19) United States
(12) Patent Application Publication
(10) Pub. No.: US 2012/0200895 A1
(43) Pub. Date: Aug. 9, 2012

(54) IMAGE FORMING METHOD AND IMAGE FORMING APPARATUS

(75) Inventor: Tatsuyoshi HAGA, Tokyo (JP)

(73) Assignee: KONICA MINOLTA BUSINESS TECHNOLOGIES, INC., Tokyo (JP)

(21) Appl. No.: 13/358,722

(22) Filed: Jan. 26, 2012

(30) Foreign Application Priority Data
Feb. 8, 2011 (JP) JP2011-024707

(51) Int. Cl. G06K 15/02

(52) U.S. Cl. 358/1.16

(57) ABSTRACT

Disclosed is an image forming apparatus, which makes it possible to output the image data written in the bitmap format from an HDD without increasing the storage capacity of the DRAM, so as to implement the image forming operation in the high speed operating mode. The apparatus comprises an HDD that is provided with a first storage area and a second storage area; a conversion processing section to convert first data, inputted from an external environment and stored in the first storage area, to second data to be employed for an image forming operation. The first data and the second data are stored into the first storage area and the second storage area, respectively. The controlling operations for reading out the second data from the second storage area and for transmitting the second data to an image forming section are implemented in synchronization with an image forming timing, thereof.

This application is based on Japanese Patent Application NO. 2011-024707 filed on Feb. 8, 2011, with Japan Patent Office, the entire content of which is hereby incorporated by reference.

### BACKGROUND OF THE INVENTION

The present invention relates to an image forming method and apparatus, each of which is to be employed for an image forming operation in such a state that the apparatus is provided with a storage device to store data in regard to the image forming operation therein.

It has been necessary for the image forming apparatus to store various kinds of data, including non-bitmap print data written in the Page Description Language before the RIP (Raster Image Processing) is applied (hereinafter, referred to as before-RIP print data), rasterized bitmap image data (hereinafter, referred to as after-RIP print data), etc., therein.

For this purpose, a HDD (Hard Disc Drive), serving as a nonvolatile mass storage for storing a large amount of image data therein, has been mounted into the image forming apparatus.

Further, in such the image forming apparatus, it is necessary to transmit the bitmap image data for every page to the image forming section in synchronization with the image forming timing, such as the exposure timing the paper sheet feed timing, etc., without generating any delay.

In this connection, due to the demands for the high image quality and the high printing speed in the image forming apparatus to be employed in the massive printing field, it has increasingly become necessary to continuously output a massive amount of image data at a high velocity. In addition, when recovering from the malfunction, such as a paper sheet jamming, etc., it is necessary to output a consecutive massive amount of image data at a high velocity and in synchronization with the timing of outputting the recording paper sheets. Under such the circumstances as abovementioned, since the data outputting rate from the HDD hardly fits the abovementioned demands, the image forming apparatus concerned has been so constituted that a consecutive amount of image data is once stored into a DRAM (Dynamic Random Access Memory), and then, outputted therefrom.

In this connection, according to such the method for using the HDD provided in the image forming apparatus as abovementioned is set forth in Tokkai 2000-59591 and Tokkai 2008-162068 (both are Japanese Patent Application Laid-Open Publications).

Tokkai 2000-59591 sets forth that, in the copier or the printer, various kinds of data are stored in the file format. Further, Tokkai 2008-162068 sets forth that the data, written in the Page Description Language and inputted from the external environment, is developed to image data in the bitmap format, which is once stored in the DRAM, so as to employ the bitmap image data for the image forming operation. However, none of them has proposed a method for utilizing the HDD in a high speed and efficient mode.

Incidentally, a high-speed printing system to be employed in the specific printing field called the “print production print”, is provided with various kinds of optional apparatus, serving as post processing apparatuses that are serially cascaded to the image forming apparatus as the multi post-processing stages, so as to yield the book-bound print products, therefrom. Further, in such the image forming system as abovementioned, since the consecutive post processing operations are continuously performed as well, it is necessary to continuously output the image data for the number of pages or copies, to be yielded in the printing operation concerned, at a high speed, so as to match the velocity of outputting the image data with the image forming timing without generating any delay. As a result, it has become necessary to mount further massive amount of the aforementioned DRAM into the image forming apparatus concerned.

In such the conventional circumstances of the image forming system as above-mentioned, since the desired capacity of the DRAM to be mounted into the image forming apparatus has become too huge, it has been tried to utilize the HDD (Hard Disc Drive), having a mass storage capacity and currently installed in the image forming apparatus for storing huge amount of data, for this purpose, instead of the DRAM.

However, owing to such the situation, inherent to the image forming apparatus, that a delay in the image data outputting operation has been generated due to the fact that the operation for accessing the HDD so as to conduct the rasterizing operation, etc., and the image data outputting operation simultaneously occur in parallel, it has been difficult to simultaneously utilize a common HDD for the two different operations.

In the abovementioned situation, although it can be considered such a countermeasure that the rasterizing operation is made to be temporarily halted so as to give a priority to the image data outputting operation, or, the plural HDDs are separately allotted to the image data outputting operation and to the rasterizing operation, there would arisen another problems that the image forming performance would be deteriorated due to the temporal halt of the rasterizing operation, the expanded installation of the HDD would result in a cost-increase, etc.

In addition to the abovementioned, sometimes, the fragmentation problem caused by the operation for fragmentizing the files, which is liable to occur when the HDD is utilized by the function of the general purpose file system, deteriorates the velocity of reading out the image data, and accordingly, it would be liable to occur such the case that the actual reading speed could not reach to the reading velocity demand established for performing the image data outputting operation. Owing to the reasons as abovementioned, conventionally, it has been difficult to utilize the HDD for the operation for outputting the image data written in the bitmap format in the image forming apparatus.

### SUMMARY OF THE INVENTION

To overcome the abovementioned drawbacks in conventional image forming apparatuses, it is one of objects of the present invention to provide an image forming method and an image forming apparatus, each of which makes it possible to output the image data written in the bitmap format from the HDD (Hard Disc Drive) without increasing the storage capacity of the DRAM (Dynamic Random Access Memory), so as to implement the image forming operation in the high speed operating mode.

Accordingly, at least one of the objects of the present invention can be attained by any one of the image forming methods and the image forming apparatus described as follows.

(1) According to an image forming method reflecting an aspect of the present invention, the image forming method, comprises: storing first data, inputted from an external environment, into a first storage area provided in a hard disc drive; converting the first data to second data, which is to be employed for an image forming operation; storing the second data into a second storage area provided in the hard disc drive; and reading out the second data from the second storage area so as to transmit the second data to an image forming section in synchronization with an image forming timing; wherein the first data stored in the first storage area, provided in the hard disc drive, is managed by employing a first management method, while the second data stored in the second storage area, provided in the hard disc drive, is managed by employing a second management method being different from the first management method.
(2) According to another aspect of the present invention, in the image forming method recited in item 1, in the hard disc drive, a second accessing velocity for accessing the second storage area is higher than a first accessing velocity for accessing the first storage area.
(3) According to still another aspect of the present invention, in the image forming method recited in item 1 or 2, in the hard disc drive, the first storage area is managed by a file system, while the second storage area is managed as a RAW (Read After Write) device.
(4) According to still another aspect of the present invention, the image forming method, recited in any one of items 1-3, further comprises: applying a RIP (Raster Image Processing) to the first data, written in a non bitmap format and inputted from the external environment, so as to convert the first data to the second data written in a bitmap format.
(5) According to still another aspect of the present invention, in the image forming method recited in any one of items 1-4, when both the first data and the second data, currently stored in the hard disc drive, are in an access waiting status, an operation for accessing the second data is prioritized over that for accessing the first data.
(6) According to still another aspect of the present invention, in the image forming method recited in any one of items 1-5, the control section conducts controlling operations so as to employ a cache storage for storing or reading the first data into/from the first storage area.
(7) According to an image forming apparatus reflecting yet another aspect of the present invention, the image forming apparatus, comprises: a hard disc drive that is provided with a first storage area, being capable of storing data therein and managed by employing a first management method, and a second storage area, being capable of storing data therein and managed by employing a second management method, which is different from the first management method; a conversion processing section to convert first data to second data, which is to be employed for an image forming operation; an image forming section to implement the image forming operation based on the second data; and a control section to control the hard disc drive, so as to store the first data, inputted from an external environment, into the first storage area, and so as to store the second data, converted from the first data by the conversion processing section, into the second storage area wherein the control section conducts controlling operations for reading out the second data from the second storage area and for transmitting the second data to the image forming section in synchronization with an image forming timing.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a schematic diagram indicating a configuration of an image forming apparatus embodied in the present invention;

FIG. 2 shows a flowchart indicating a flow of operations to be conducted in an image forming apparatus embodied in the present invention;

FIG. 3 shows an explanatory schematic diagram indicating an outlined flow of processing to be conducted in an image forming apparatus embodied in the present invention;

FIG. 4 shows an explanatory schematic diagram indicating an exemplified processing to be conducted in an image forming apparatus embodied in the present invention;

FIG. 5 shows an explanatory schematic diagram indicating another exemplified processing to be conducted in an image forming apparatus embodied in the present invention;

FIG. 6 shows an explanatory schematic diagram indicating still another exemplified processing to be conducted in an image forming apparatus embodied in the present invention; and

FIG. 7 shows an explanatory schematic diagram indicating yet another exemplified processing to be conducted in an image forming apparatus embodied in the present invention.

### DETAILED DESCRIPTION OF THE PREFERRED EMBODIMENT

Referring to the drawings, the preferred embodiment of the present invention will be detailed in the following. Hereinafter, an image forming apparatus 100 that has functions of: receiving image data written in a non-bitmap format from an external apparatus; rasterizing the image data so as to convert the image data to bitmap image data written in the bitmap format; forming an image based on the bitmap image data; and storing the bitmap image data therein, will be detailed as an concrete example embodied in the present invention.

### <Configuration of Image Forming Apparatus>

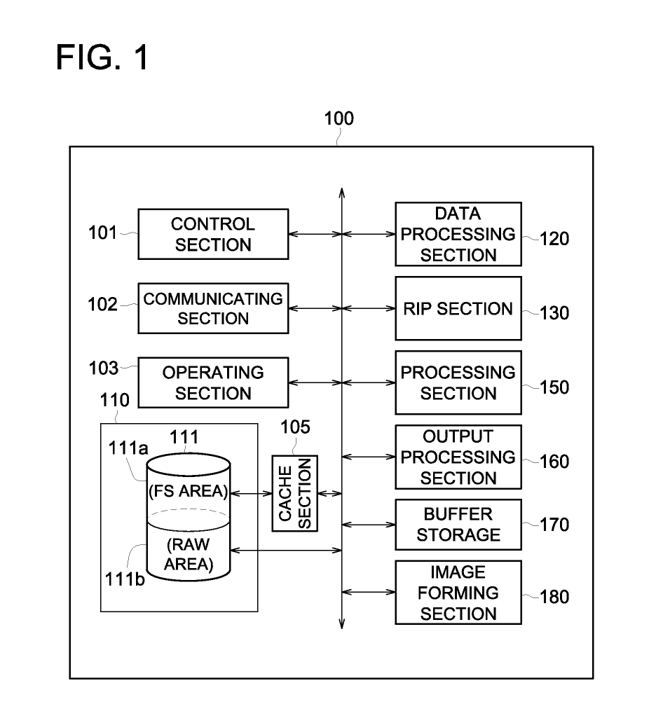

The image forming apparatus 100, the configuration of which is indicated by the schematic diagram shown in FIG. 1, is constituted by: a control section 101 that includes a CPU (Central Processing Unit), etc., so as to control various kinds of sections provided in the image forming apparatus 100; a communicating section 102 to communicate with other apparatuses through one or plural kinds of networks; an operating section 103 that is configured by an LCD (Liquid Crystal Display) section and a touch panel so as to make it possible for the user to input various kinds of operations therefrom; a storage device 110 that is provided with an HDD (Hard Disc Drive), serving as a nonvolatile storage device, into which various kinds of data sets to be handled by the image forming apparatus 100 are stored; a data processing section 120 that conducts the processing for storing before-RIP print data, written in the Page Description Language serving as the non-bitmap format and received from an external apparatus, into the storage device 110; a RIP section 130 that applies the RIP (Raster Image processing) to the before-RIP print data so as to generate after-RIP print data written in the bitmap format; an image processing section 150 that applies the compression processing to the after-RIP print data, which is to be stored into the storage device 110, and then, reads out the after-RIP print data compressed and stored in the above process, so as to apply the expansion processing to the after-RIP print data above-read; an output processing section 160 that applies various kinds of processing, in regard to the image forming output operations, to the after-RIP print data a buffer storage 170 that is constituted by a DRAM (Dynamic Random Access Memory), which make it possible to output the after-RIP print data at a high speed so as to match the velocity of outputting the after-RIP print data with the timing for outputting the recording paper sheet; and an image forming section 180, serving as a printer engine that implements the image forming and outputting operations by employing the electro-photographic method, or the like.

A cache section 105 is formed by allotting a part of storage, which is controlled by an OS (Operating System) to be executed by the control section 101, as a cache storage, which makes it possible to conduct the storing and reading operations at a velocity higher than that of the storage device 110 detailed later, and hereinafter, also referred to as a cache for simplicity. In this connection, although the cache section 105 is inserted between the storage device 110 and the bus line in the schematic diagram shown in FIG. 1, in order to schematically indicate the operating status thereof, the cache section 105 is not necessary inserted into the abovementioned position in the practical configuration.

In this connection, the storage device 110 is provided with an HDD 111 to store various kinds of data therein, and for this purpose, the whole storage area of the HDD 111 is partitioned into an FS (File Section) area 111a, serving as a first storage area, and a RAW (Read After Write) area 111b, serving as a second storage area. In this connection, the method for managing the data to be stored into the FS area 111a, serving as the first storage area, is different from that for managing the other data to be stored into the RAW area 111b, serving as the second storage area, as detailed later on. Further, hereinafter, the before-RIP print data to be inputted from the external environment is defined as first data, while, the after-RIP print data to which the RIP has been applied is defined as second data.

The FS area 111a is such a storage area that is controlled by the file system of the OS (Operating System), and stores image data, which has been instructed to store therein by the user through the operating section 103, in a reusable manner, so as to make it possible for the user to reuse the concerned image data by retrieving it on the basis of the file name and/or various kinds of attributes, thereafter. Accordingly, although the data writing and reading velocities are not weighted heavily so much, it is possible to conduct various kinds of managing (controlling) and utilizing operations according to the file system. In this connection, in the embodiment shown in FIG. 1, the cache section 105 is employed on an occasion for storing or reading the before-RIP print data, serving as the first data, into/from the FS area 111a serving as the first storage area of the storage device 110. However, sometimes, the velocity of reading the image data would be deteriorated due to the fragmentation problem caused by the fragmentized file in the FS area 111a. Further, although it is possible to employ the cache section 105 for accessing the FS area 111a and it is also possible to achieve the high-velocity accessing operation at the time of the cache hitting status, sometimes, the access performance would be degraded at the time of the cache miss-hitting status. In this connection, in the embodiment shown in FIG. 1, such the before-RIP print data that includes a plurality of data sets, which is possibly to be stored as it is for a long time until the time for implementing the image forming and outputting operations arrives, is stored into the FS area 111a.

On the other hand, the RAW area 111b is such a storage area that is controlled as a RAW device by the control section 101, and that temporarily stores image data as a virtual storage area to compensate for the capacity shortage of the nonvolatile storage, in order to output the image data at a predetermined timing. Accordingly, since it is demanded to speedily conduct the data writing and reading operations, the control section 101 directly conducts the data management operations, so that the image data for one page is written into the continuous series of sectors under the managing operations in regard to the sector numbers and the data storage capacity.

In this connection, although the various kinds of attributes and the cache, which are to be employed for the file system, are not employed for the RAW area 111b, by conducting the data management operations described as abovementioned, it becomes possible to perform the high-speed data accessing operations (storing and reading operations) in the state more stable than ever. In this connection, in the embodiment shown in FIG. 1, the after-RIP print data, which should be outputted in a high speed outputting mode at the time of image forming and outputting operations, is stored into the RAW area 111b. Further, in order to achieve the high-velocity accessing operation more speedily than ever, the RAW area 111b is allotted to the outside area of the disc, included in the HDD 111, more outer than the FS area 111a.

Incidentally, the image forming apparatus 100, embodied in the present invention, is a high-speed image forming apparatus to be employed in the image forming system of the specific printing field called the “print production print”, and the image forming system 100 is so constituted that various kinds of optional apparatus, serving as post processing apparatuses that are serially cascaded following to the final stage of the image forming apparatus 100 as the multi post-processing stages (not shown in the drawings), so as to yield the book-bound print products, therefrom. In this connection, since the consecutive post processing operations should be continuously implemented in this kind of the image forming system, it is also necessary to continuously output the image data for a number of pages or copies to be printed in a high speed operating mode without generating any delay, while synchronizing with the image forming timings of them. For this purpose, as detailed later on, the image forming apparatus 100, embodied in the present invention, employs such a novel method that makes the HDD of the storage device 110 available in the high speed operating mode, so as to make it possible to employ a minimum capacity of DRAM, which is necessary for storing image data of two pages, for alternately conducting the storing and reading operations to be conducted by the buffer storage 170.

### <Operations of Image Forming Apparatus>

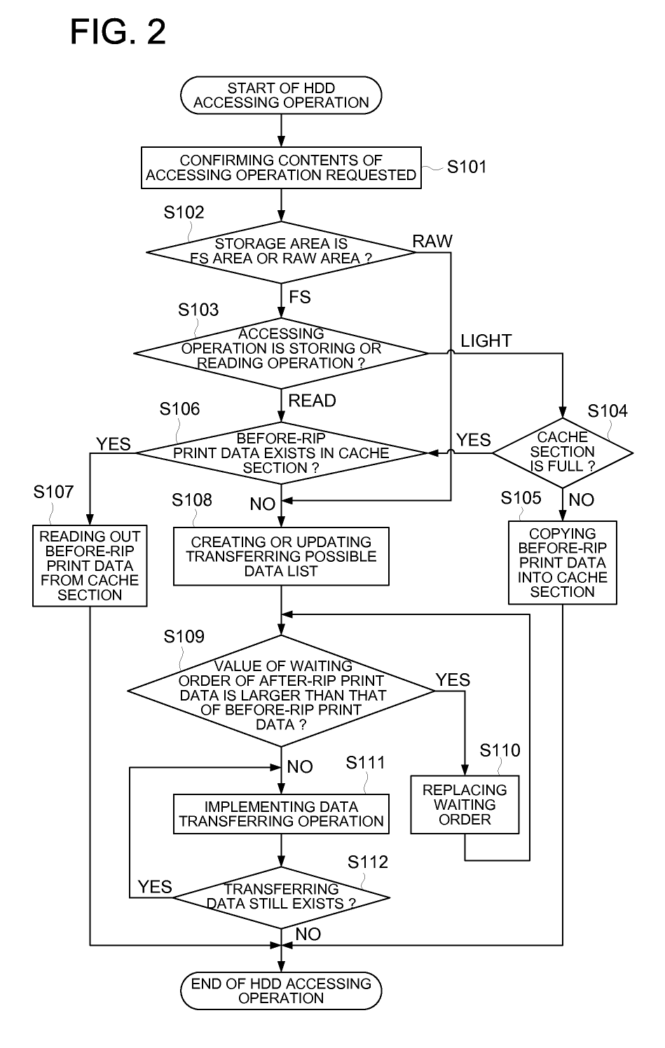

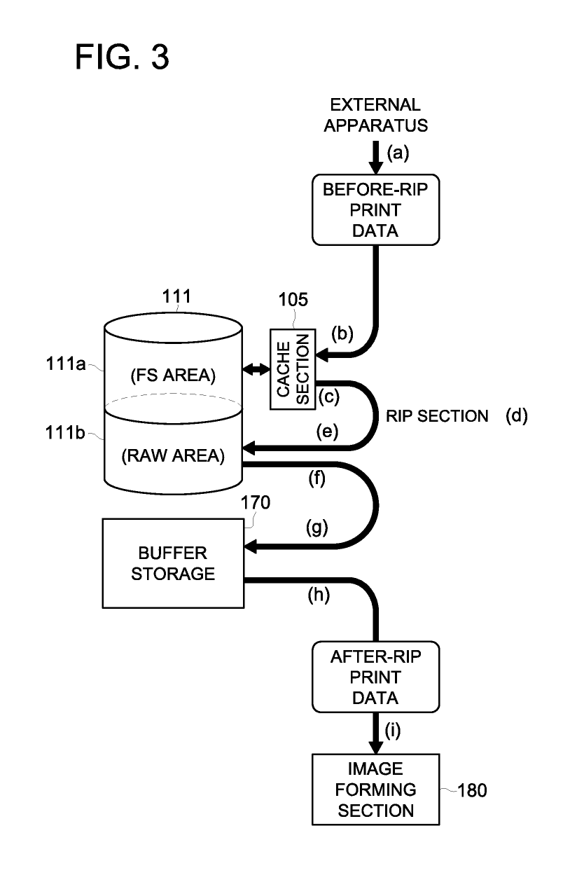

Now, the image forming operations to be conducted in the image forming apparatus 100, embodied in the present invention, will be detailed in the following. Herein, referring to the flowchart, shown in FIG. 2, indicating a storage/access controlling operations to be conducted by the control section 101, and the explanatory schematic diagrams, shown in FIG. 3 through FIG. 6, indicating data flowing sequences, the explanations will be given in the following. In this connection, a term of “transferring operation” will be employed for referring to both an operation for storing (or writing) data into the storage device 110 and another operation for outputting (or reading) data from the storage device 110 as the general term of them.

The control section 101 monitors the contents of the accessing operations for the storage device 110 in regard to the data transferring operations, such as a data storing or reading operation or the like, and, when receiving the request for accessing the storage device 110, confirms the contents of the requested accessing operation, including whether the concerned storage area is the FS area 111a or the RAW area 111b and whether the accessing operation is the storing operation or the reading operation (Step S101, Step S102 and Step S103 in the flowchart shown in FIG. 2).

When receiving before-RIP print data sent from an external apparatus (arrow “a” shown in FIG. 3), the control section 101 determining that the external apparatus requests the control section 101 to write the before-RIP print data into the FS area 111a of the storage device 110 as the accessing request for writing operation (Step S102; FS and Step S103; WRITE, in the flowchart shown in FIG. 2).

Successively, the control section 101 detects the currently available space of the cache section 105, and when determining that a space sufficiently available for copying the before-RIP print data therein remains within the capacity of the cache section 105 (Step S104; No, in the flowchart shown in FIG. 2), the combination of the control section 101 and the data processing section 120 copies the before-RIP print data into the cache section 105 (Step S105 in the flowchart shown in FIG. 2, arrow “b” shown in FIG. 3) without writing it into FS area 111a at this time, and finalizes the processing of the flowchart. In this connection, as the delayed writing operation in the cache processing, at a timing when no accessing operation is per formed for the storage device 110, the combination of the control section 101 and the data processing section 120 stores the before-RIP print data, currently copied into the cache section 105, into the FS area 111a, so as to make the contents of data stored in the cache section 105 coincide with those stored in the FS area 111a.

On the other hand, when determining that the available space does not remain within the capacity of the cache section 105 (Step S104; Yes, in the flowchart shown in FIG. 2), as a preparation for storing the before-RIP print data into the FS area 111a of the storage device 110, the control section 101 creates or updates a transferring possible data list in regard to the operation for making the before-RIP print data access into the storage device 110 (Step S108 in the flowchart shown in FIG. 2). In this connection, operations for replacing transfer waiting orders with each other and for implementing the transferring operation, based on the transferring possible data list, will be detailed later on.

When reading the before-RIP print data stored in the FS area 111a of the storage device 110 to make the RIP section 130 apply the RIP to the before-RIP print data (arrow “c” shown in FIG. 3), the control section 101 determining that the RIP section 130 requests the control section 101 to read out the before-RIP print data from the FS area 111a of the storage device 110 as the accessing request for reading operation (Step S102; FS and Step S103; READ, in the flowchart shown in FIG. 2).

Successively, the control section 101 confirms whether or not the before-RIP print data to be read out exists within the cache section 105 (Step S106 in the flowchart shown in FIG. 2), and when determining that the before-RIP print data to be read out exists within the cache section 105 (Step S106; Yes, in the flowchart shown in FIG. 2), the combination of the control section 101 and the data processing section 120 reads out the before-RIP print data from the cache section 105 so as to supply the before-RIP print data to the RIP section 130 (Step S107 in the flowchart shown in FIG. 2), and then, finalizes the processing of this flowchart (END).

On the other hand, when determining that the before-RIP print data to be read out does not exist within the cache section 105 (Step S106; No, in the flowchart shown in FIG. 2), as a preparation for reading out the before-RIP print data from the FS area 111a of the storage device 110, the control section 101 creates or updates the transferring possible data list in regard to the operation for making the before-RIP print data access into the storage device 110 (Step S108 in the flowchart shown in FIG. 2). In this connection, the operations for replacing the transfer waiting orders with each other and for implementing the transferring operation, based on the transferring possible data list, will be detailed later on.

When storing the after-RIP print data, generated by applying the RIP to the before-RIP print data in the RIP section 130, into the FS area 111a of the storage device 110 (arrow “e” shown in FIG. 3), or when reading out the after-RIP print data currently stored in the FS area 111a of the storage device 110 (arrow “f” shown in FIG. 3) and supplying the after-RIP print data to the image forming section 180 through the buffer storage 170 so as to implement the image forming operation (arrows “g”, “h” and “i” shown in FIG. 3), as the contents of the accessing operations, the control section 101 determining that the abovementioned operations are requests for accessing the RAW area 111b of the storage device 110 (Step S102; RAW, in the flowchart shown in FIG. 2).

Successively, as a preparation for accessing the RAW area 111b of the storage device 110 in regard to the after-RIP print data, the control section 101 creates or updates the transferring possible data list (Step S108 in the flowchart shown in FIG. 2).

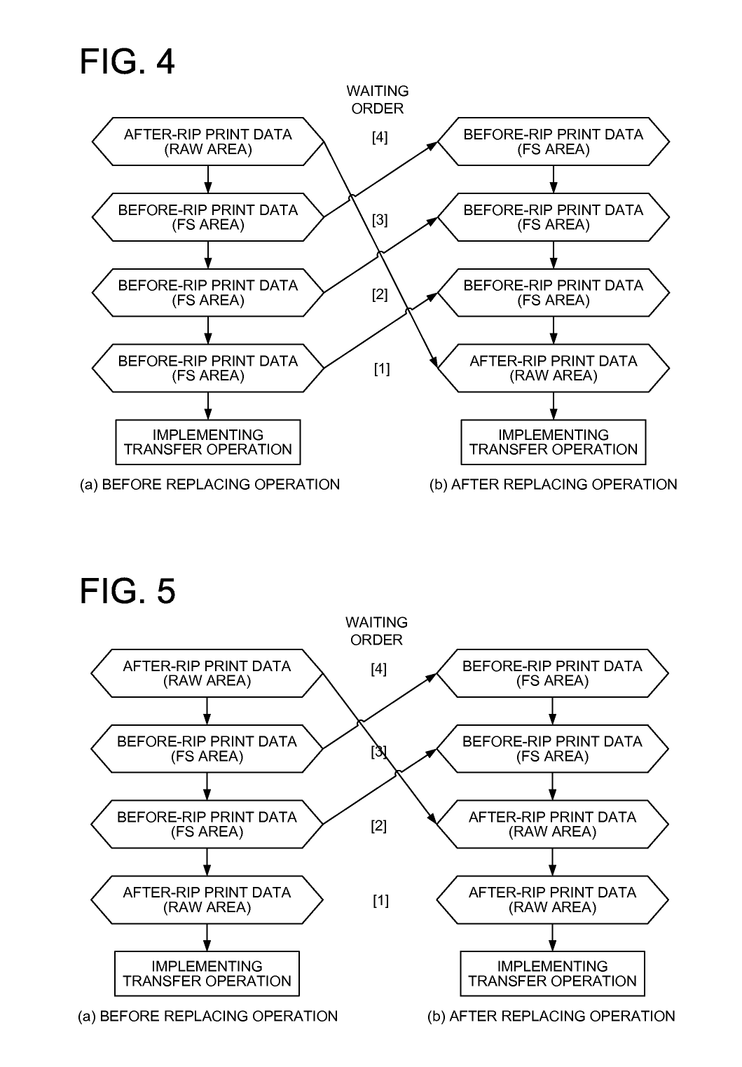

In this connection, the transferring possible data list, created in the preparation of the transferring operation described in the foregoing (Step S108 in the flowchart shown in FIG. 2), includes the name of data concerned, the kind of print data indicating either the before-RIP print data or the after-RIP print data, the kind of access destination indicating either the FS area 111a or the RAW area 111b, the waiting order, etc. FIG. 4 shows a schematic diagram indicating a concrete example of waiting orders [1]-[4].

Successively, based on the transferring possible data list, the control section 101 detects the waiting order (any one of waiting orders [1]-[4] indicted in column (a) shown in FIG. 4) in regard to the accessing (data transferring) operation, such as the operation for storing (writing) data into the storage device 110, the operation for reading out data from the storage device 110, or the like, and the kind of access destination, so as to determine whether or not the waiting order of the after-RIP print data of the RAW area 111b is later (value of waiting order concerned is larger) than that of the before-RIP print data of the FS area 111a (Step S109 in the flowchart shown in FIG. 2).

Still successively, when both the before-RIP print data and the after-RIP print data are currently in the access waiting status, the control section 101 updates the waiting order on the transferring possible data list, so as to give a priority to the operation for accessing the after-RIP print data. In this connection, with respect to the after-RIP print data, the waiting order of which is already ranked at a positioned being neat to the leading top position, the control section 101 does not update the waiting order thereof.

Concretely speaking, since the after-RIP print data having waiting order [4] is ranked at the position being later than before-RIP print data having waiting orders [1]-[3] in column (a) shown in FIG. 4, the control section 101 sets back each of the waiting orders of the before-RIP print data one by one, so as to replace current waiting order [4] of the after-RIP print data with waiting order [1] serving as the leading top position as indicated in column (b) shown in FIG. 4 (Step S110 in the flowchart shown in FIG. 2).

Further, in column (a) shown in FIG. 5, although the after-RIP print data having waiting order [4] is ranked at the position being later than before-RIP print data having waiting orders [2]-[3], since the other after-RIP print data is already ranked at the leading top position of waiting order [1], the control section 101 sets back each of waiting orders [2]-[3] of the before-RIP print data one by one, so as to replace currently rearmost waiting order [4] of the concerned after-RIP print data with waiting order [2], which is raked at the position next to the leading top position as indicated in column (b) shown in FIG. 5 (Step S110 in the flowchart shown in FIG. 2).

As described in the above, when both the before-RIP print data and the after-RIP print data are currently in the access waiting status, the data transferring operation is implemented on the basis of the transferring possible data list, which has been updated so as to give a priority to the operation for accessing the storage device 110 in regard to the after-RIP print data to be fed to the image forming section 180 (Step S111 in the flowchart shown in FIG. 2). Namely, the control section 101 make the HDD 111 implement the writing or reading operation. In this connection, when the data, which is currently in the state of waiting for the data transferring operation, still exists in the transferring possible data list abovementioned, the control section 101 repeats the data transferring operation (Step S112; Yes, and Step S111 in the flowchart shown in FIG. 2).

In this connection, it is desirable that the DMA (Direct Memory Access) transferring operation, which is to be implemented by the transfer controller (not shown in the drawings) according to the data transferring command issued by the control section 101, is employed as the data transferring operation abovementioned, from the viewpoints of the improvement of the data transferring velocity and the reduction of the load to be incurred to the control section 101.

As described in the foregoing, by respectively storing the before-RIP print data and the after-RIP print data into the FS area 111a and the RAW area 111b, both provided in the storage device 110, it becomes possible to output the after-RIP print data to the image forming section 180 in the high speed data-outputting mode, so as to achieve the high-speed image forming operation. Further, by prioritizing the operation for accessing the after-RIP print data over the other operation for accessing the before-RIP print data, it becomes possible not only to preferentially output the after-RIP print data to the image forming section 180 in the high speed data-outputting mode, so as to achieve the high-speed image forming operation, but also to satisfy both of the operation for accessing the after-RIP print data and the other operation for accessing the before-RIP print data, both of which are to be implemented for the same HDD 111 provided in the storage device 110.

### <Other Configurations of Storage Device>

Incidentally, due to the demands for the high-quality image forming capability and the high-speed printing performance, which are required for the image forming apparatus 100 to be employed in the printing field, it has become necessary to continuously output a large amount of image data at a high velocity rate, more massive than ever. Owing to such the circumstances, sometimes, it has become difficult for the storage device 110 that is provided with only a single set of the HDD 111, as shown in FIG. 1 and FIG. 3, to satisfy the demands for the storage capacity and the high-speed printing performance above-mentioned.

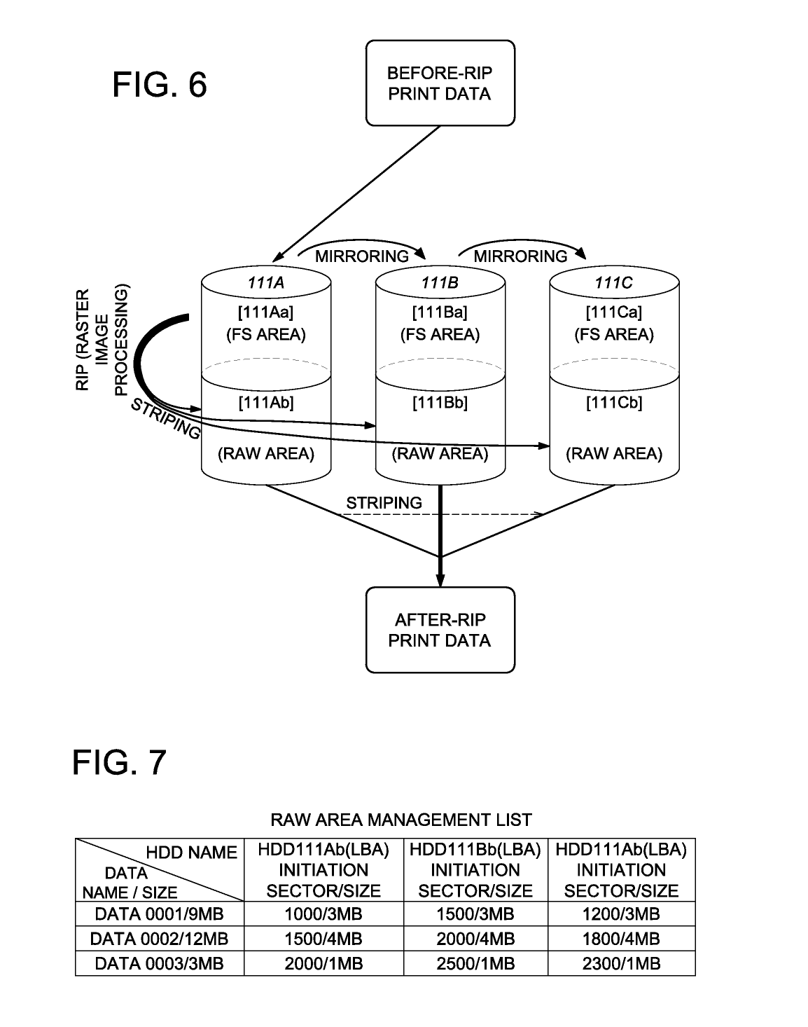

To cope with the abovementioned demands, it is possible to employ such the storage device 110 that is provided with a plurality of HDDs 111 including an HDD 111A, an HDD 111B and an HDD 111C as shown in FIG. 6. In this case, the storage device 110 is so constituted that the storage area of each of all HDDs 111 including the HDD 111A, the HDD 111B and the HDD 111C is partitioned into the FS area 111a and the RAW area 111b.

Further, with respect to the FS areas, due to the characterized role for storing the before-RIP print data sent from the external apparatus or the like, therein, by operating the HDDs 111, including the HDD 111A, the HDD 111B and the HDD 111C, in the mirroring mode so as to make each of them store the same data, it becomes possible to improve the reliability of the system and to cope with the destruction of the data. Still further, with respect to the FS areas included in the plural HDDs 111, it is also applicable that the roles of the plural HDDs 111 are respectively specified according to various kinds of intended usages, including a usage for storing before-RIP print data to be employed for a printing operation immediately-after, a usage for storing the before-RIP print data to be employed for a printing operation currently suspended but to be kept as it is, a usage for storing scanned data outputted from a scanner, etc.

Still further, with respect to the RAW area 111b, by making each of the HDD 111A, the HDD 111B and the HDD 111C store the divided data in parallel as the striping mode, it becomes possible to implement the operations for storing and reading the after-RIP print data at a velocity being far higher that those implemented by the single HDD 111. In this case, the lager the number of HDDs is, the higher the improvement level of the data transferring velocity becomes. Yet further, in this case, with respect to the initiation sectors and the data sizes respectively corresponding to the HDD 111A, the HDD 111B and the HDD 111C, the control section 101 creates a RAW area management list as shown in FIG. 7, in order to conduct controlling operations for performing the striping operation mode, while managing the RAW area management list.

### <Effects of Image Forming Method and Apparatus, Embodied in the Present Invention>

As described in the foregoing since the data accessing velocity to be employed for the RAW area serving as the second storage area is higher than that to be employed for the FS area serving as the first storage area, it becomes possible to output the image data written in the bitmap format (after-RIP print data) from the HAD to the image forming section, without increasing the storage capacity of the DRAM provided in the buffer storage 170, and as a result, it becomes possible to implement the image forming operation at a high speed rate.

Further, herein, the velocity of the data accessing operation conducted in the RAW area controlled as the RAW device is higher that that in the FS area controlled by the file system, and accordingly, it becomes possible to output the image data written in the bitmap format (after-RIP print data) from the HDD to the image forming section, without increasing the storage capacity of the DRAM provided in the buffer storage 170, and as a result, it becomes possible to implement the image forming operation at a high speed rate.

Still further, when both the before-RIP print data and the after-RIP print data are in the access waiting status for the HDD 111, by prioritizing the operation for accessing the after-RIP print data to be employed for the actual image forming operation over that for the before-RIP print data, it becomes possible to speedily output the after-RIP print data written in the bitmap format from the HDD 111 to the image forming section 180 so as to implement the image forming operation in the high velocity mode, and as a result, it becomes possible to make the operation for accessing the before-RIP print data, to which the RIP is to be applied, and that for accessing the after-RIP print data, which is to be employed for implementing the image forming operation, compatible in the same HDD 111.

Still further, by configuring the image forming apparatus 100 in such a manner that the cache section 105 is not employed for accessing the after-RIP print data, though the cache section 105 is employed for accessing the before-RIP print data, it becomes possible to always conduct the operation for reading the after-RIP print data in a stable state, without generating any change in the access velocity when accessing the after-RIP print data, caused by occurrences of the cache hit or the cache miss. As a result, it becomes possible to speedily output the after-RIP print data written in the bitmap format from the HDD 111 to the image forming section, so as to implement the image forming operation in the high velocity and stable operating mode.

Yet further, when the HDD 111 is constituted by a plurality of HDDs, by configuring the HDD 111 in such a manner that each of the plural HDDs is provided with the FS area and the RAW area, and by operating the RAW area in the striping operation mode, it becomes possible to speedily output the after-RIP print data written in the bitmap format from each of the plural HDDs to the image forming section, so as to implement the image forming operation in the high velocity and stable operating mode.

According to present invention, the following advantageous effects can be attained.

In the image forming apparatus embodied in the present invention, when the different management methods are respectively employed for managing the first storage area and the second storage area, the first data, written in a non-bitmap format and inputted from an external environment for implementing an image forming operation, is stored into the first storage area. Then, the RIP is applied to the first data so as to convert the first data to the second data written in the bitmap format and the second data is stored into the second storage area, so that the second data is read out from said second storage area so as to transmit said second data to the image forming section in synchronization with the image forming timing.

Herein, since the accessing velocity for accessing said second storage area is higher than that for accessing said first storage area, it becomes possible to output the image data written in the bitmap format from the HDD to the image forming section, without increasing the storage capacity of the DRAM, and as a result, it becomes possible to implement the image forming operation at a high speed rate.

Further, herein, since the accessing velocity for accessing said second storage area, which is managed as a RAW device, is higher than that for accessing said first storage area, which is managed by a file system, it becomes possible to output the image data written in the bitmap format from the HDD to the image forming section, without increasing the storage capacity of the DRAM, and as a result, it becomes possible to implement the image forming operation at a high speed rate.

Still further, when both the first data and the second data, currently stored in the hard disc drive, are in the access waiting status, by prioritizing the operation for accessing said second data, which is to be directly employed for the image forming operation, over that for accessing said first data, it becomes possible to speedily output the image data written in the bitmap format from the HDD to the image forming section so as to implement the image forming operation in the high velocity mode, and as a result, it becomes possible to make the operation for accessing the first data, to which the RIP is to be applied, and that for accessing the second data, which is to be employed for implementing the image forming operation, compatible in the same HDD.

Still further, by configuring the image forming apparatus in such a manner that the cache storage is not employed for accessing the second data in the second storage area, though the cache storage is employed for accessing the first data in the first storage area, it becomes possible to always conduct the operation for reading the second data in a stable state, without generating any change in the access velocity when accessing the second data, caused by occurrences of the cache hit or the cache miss. As a result, it becomes possible to speedily output the image data written in the bitmap format from the HDD to the image forming section, so as to implement the image forming operation in the high velocity and stable operating mode.

Yet further, when the HDD storage is constituted by a plurality of HDDs, by configuring the HDD storage in such a manner that each of the plural HDDs is provided with the first area and the second area, and by operating the second area in the striping operation mode, it becomes possible to speedily output the image data written in the bitmap format from the HDD storage to the image forming section, so as to implement the image forming operation in the high velocity and stable operating mode.

While the preferred embodiments of the present invention have been described using specific term, such description is for illustrative purpose only, and it is to be understood that changes and variations may be made without departing from the spirit and scope of the appended claims.

What is claimed is:

1. An image forming method, comprising:
storing first data, inputted from an external environment, into a first storage area provided in a hard disc drive;
converting the first data to second data, which is to be employed for an image forming operation;
storing the second data into a second storage area provided in the hard disc drive; and
reading out the second data from the second storage area so as to transmit the second data to an image forming section in synchronization with an image forming timing;
wherein the first data stored in the first storage area, provided in the hard disc drive, is managed by employing a first management method, while the second data stored in the second storage area, provided in the hard disc drive, is managed by employing a second management method being different from the first management method.

2. The image forming method of claim 1,
wherein, in the hard disc drive, a second accessing velocity for accessing the second storage area is higher than a first accessing velocity for accessing the first storage area.

3. The image forming method of claim 1,
wherein, in the hard disc drive, the first storage area is managed by a file system, while the second storage area is managed as a RAW (Read After Write) device.

4. The image forming method of claim 1, further comprising:
applying a RIP (Raster Image Processing) to the first data, written in a non-bitmap format and inputted from the external environment, so as to convert the first data to the second data written in a bitmap format.

5. The image forming method of claim 1,
wherein, when both the first data and the second data, currently stored in the hard disc drive, are in an access waiting status, an operation for accessing the second data is prioritized over that for accessing the first data.

6. The image forming method of claim 1,
wherein the control section conducts controlling operations so as to employ a cache storage for storing or reading the first data into/from the first storage area.

7. An image forming apparatus, comprising:
a hard disc drive that is provided with a first storage area, being capable of storing data therein and managed by employing a first management method, and a second storage area, being capable of storing data therein and managed by employing a second management method, which is different from the first management method;
a conversion processing section to convert first data to second data, which is to be employed for an image forming operation;
an image forming section to implement the image forming operation based on the second data; and
a control section to control the hard disc drive, so as to store the first data, inputted from an external environment, into the first storage area, and so as to store the second data, converted from the first data by the conversion processing section, into the second storage area;
wherein the control section conducts controlling operations for reading out the second data from the second storage area and for transmitting the second data to the image forming section in synchronization with an image forming timing.

8. The image forming apparatus of claim 7,
wherein, in the hard disc drive, a second accessing velocity for accessing the second storage area is higher than a first accessing velocity for accessing the first storage area.

9. The image forming apparatus of claim 7,
wherein, in the hard disc drive, the first storage area is managed by a file system, while the second storage area is managed as a RAW (Read After Write) device.

10. The image forming apparatus of claim 7,
wherein the conversion processing section applies a RIP (Raster Image Processing) to the first data, written in a non-bitmap format and inputted from the external environment, so as to convert the first data to the second data written in a bitmap format.

11. The image forming apparatus of claim 7,
wherein, when both the first data and the second data, currently stored in the hard disc drive, are in an access waiting status, the control section prioritizes an operation for accessing the second data over that for accessing the first data.

12. The image forming apparatus of claim 7,
wherein the control section conducts controlling operations so as to employ a cache storage for storing or reading the first data into/from the first storage area.
